(19) United States
(12) Patent Application Publication
(10) Pub. No.: US 2024/0104389 A1
(43) Pub. Date: Mar. 28, 2024

(54) NEURAL NETWORK REINFORCEMENT LEARNING WITH DIVERSE POLICIES

(71) Applicant: DeepMind Technologies Limited, London (GB)

(72) Inventors: Tom Ben Zion Zahavy, London (GB); Brendan Timothy O'Donoghue, London (GB); Andre da Motta Salles Barreto, London (GB); Johan Sebastian Flennerhag, London (GB); Volodymyr Mnih, Toronto (CA); Satinder Singh Baveja, Ann Arbor, MI (US)

(21) Appl. No.: 18/275,511

(22) PCT Filed: Feb. 4, 2022
(86) PCT No.: PCT/EP2022/052788

§ 371 Date: Aug. 2, 2023

Related U.S. Application Data
(60) Provisional application No. 63/146,253, filed on Feb. 5, 2021.

(51) Int. Cl. G06N 3/092

(52) U.S. Cl. CPC G06N 3/092

(57) ABSTRACT

In one aspect there is provided a method for training a neural network system by reinforcement learning. The neural network system may be configured to receive an input observation characterizing a state of an environment interacted with by an agent and to select and output an action in accordance with a policy aiming to satisfy an objective. The method may comprise obtaining a policy set comprising one or more policies for satisfying the objective and determining a new policy based on the one or more policies. The determining may include one or more optimization steps that aim to maximize a diversity of the new policy relative to the policy set under the condition that the new policy satisfies a minimum performance criterion based on an expected return that would be obtained by following the new policy.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes methods for training a neural network system that selects actions to be performed by an agent interacting with an environment. The reinforcement learning methods described herein can be used to learn a set of diverse, near optimal policies. This provides alternative solutions for a given task, thereby providing improved robustness.

In one aspect there is provided a method for training a neural network system by reinforcement learning. The neural network system may be configured to receive an input observation characterizing a state of an environment interacted with by an agent and to select and output an action in accordance with a policy aiming to satisfy an objective. The method may comprise obtaining a policy set comprising one or more policies for satisfying the objective and determining a new policy based on the one or more policies. The determining may include one or more optimization steps that aim to maximize a diversity of the new policy relative to the policy set under the condition that the new policy satisfies a minimum performance criterion based on an expected return that would be obtained by following the new policy.

In light of the above, methods described herein aim to obtain a diverse set of policies by maximizing the diversity of the policies subject to a minimum performance criterion. This differs from other methods that may attempt to maximize the inherent performance of the policies, rather than comparing policies to ensure that they are diverse.

Diversity may be measured through a number of different approaches. In general, the diversity of a number of policies represents differences in the behavior of the policies. This may be measured through differences in parameters of the policies or differences in the expected distribution of states visited by the policies.

The methods described herein may be implemented through one or more computing devices and/or one or more computer storage media.

According to one implementation there is provided a system comprising one or more computers and one or more storage devices storing instructions that when executed by the one or more computers cause the one or more computers to the methods described herein.

According to a further implementation there is provided one or more (transitory or non-transitory) computer storage media storing instructions that when executed by one or more computers cause the one or more computers to perform the methods described herein.

Particular embodiments of the subject matter described in this specification can be implemented so as to realize one or more of the following advantages.

The subject matter described in this specification introduces methods for determining a set of diverse policies for performing a particular objective. By obtaining a diverse set of policies, different approaches to the problem (different policies) may be applied, e.g. depending on the situation or in response to one of the other policies not performing adequately. Accordingly, obtaining a set of diverse policies can be useful for exploration, transfer, hierarchy, and robustness. The resultant set of diverse policies can either be applied independently, or as a mixed policy, that selects policies from the set based on a probability distribution.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a reinforcement learning system.

FIG. 2 is a flow diagram of an example process for training a reinforcement learning system.

FIG. 3 is a flow diagram of an example process for iteratively updating parameters of a new policy.

Like reference numbers and designations in the various drawings indicate like elements.

### DETAILED DESCRIPTION

The present disclosure presents an improved reinforcement learning method in which training is based on extrinsic rewards from the environment and intrinsic rewards based on diversity. An objective function is provided that combines both performance and diversity to provide a set of diverse policies for performing a task. By providing a diverse set of policies, the methods described herein provide multiple means of performing a given task, thereby improving robustness.

The present application provides the following contributions. An incremental method for discovering a diverse set of near-optimal policies is proposed. Each policy in the set may be trained based on iterative updates that attempt to maximize diversity relative to other policies in the set under a minimum performance constraint. For instance, the training of each policy may solve a Constrained Markov Decision Process (CMDP). The main objective in the CMDP can be to maximize the diversity of the growing set, measured in the space of Successor Features (SFs), and the constraint is that the policies are near-optimal. Whilst a variety of diversity rewards may be used, various explicit diversity rewards are described herein that aim to minimize the correlation between the SFs of the policies in the set. The methods described herein have been tested in and it has been found that, given an extrinsic reward (e.g. for standing or walking) the methods described herein discover qualitatively diverse locomotion behaviors for approximately maximizing this reward.

The reinforcement learning methods described herein can be used to learn a set of diverse policies. This is beneficial as it provides a means of obtaining multiple different policies reflecting different approaches to performing a task. Finding different solutions to the same problem (e.g. finding multiple different policies for performing a given task) is a long-standing aspect of intelligence, associated with creativity. In reinforcement learning, a set of diverse policies can be useful for exploration, transfer, hierarchy, and robustness. For instance, many problems of interest may have many qualitatively different optimal or near-optimal policies. Finding such diverse set of policies may help a reinforcement learning agent to become more robust to changes in the task and/or environment, as well as to generalize better to future tasks.

There are many potential applications for the present framework. For example, consider the process of using reinforcement learning to train a robot to walk. The designer does not know a priori which reward will result in the desired walking pattern. Thus, robotic engineers often train a policy to maximize an initial reward, tweak the reward, and iterate until they reach the desired behavior. Using the present approach, the engineer would have multiple forms of walking to choose from in each attempt, thereby speeding up the process of training the robot.

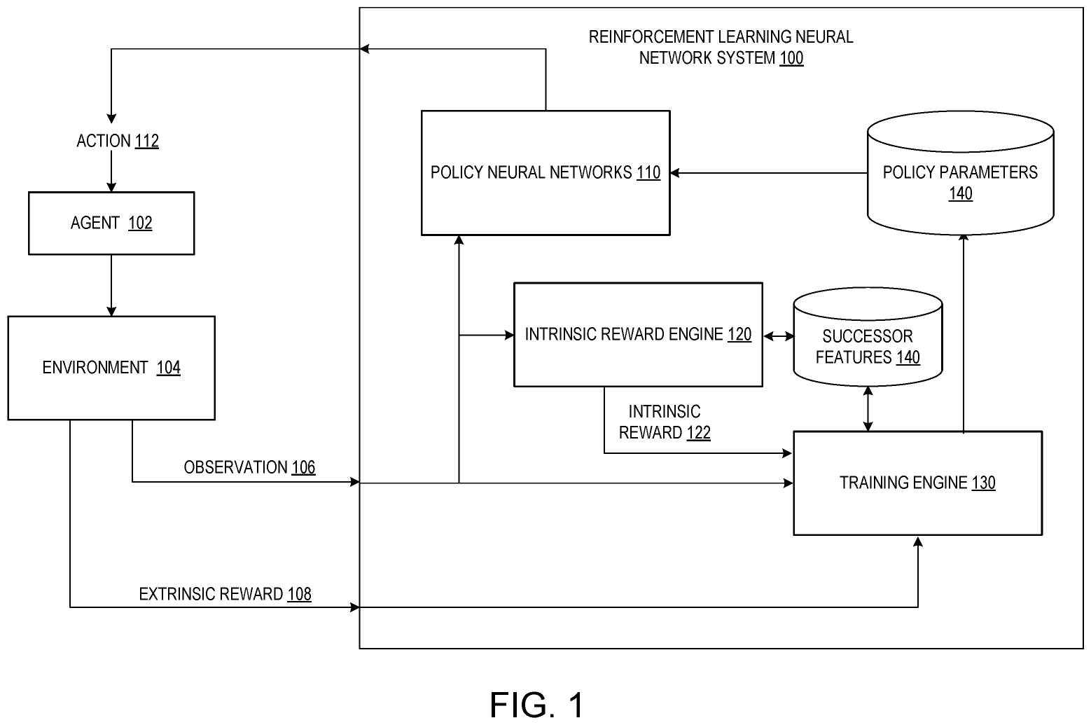

FIG. 1 shows an example of a reinforcement learning neural network system 100 that may be implemented as one or more computer programs on one or more computers in one or more locations. The reinforcement learning neural network system 100 is used to control an agent 102 interacting with an environment 104 to perform one or more tasks, using reinforcement learning techniques.

The reinforcement learning neural network system 100 has one or more inputs to receive data from the environment characterizing a state of the environment, e.g. data from one or more sensors of the environment. Data characterizing a state of the environment is referred to herein as an observation 106.

The data from the environment can also include extrinsic rewards (or task rewards). Generally an extrinsic reward 108 is represented by a scalar numeric value characterizing progress of the agent towards the task goal and can be based on any event in, or aspect of, the environment. Extrinsic rewards may be received as a task progresses or only at the end of a task, e.g. to indicate successful completion of the task. Alternatively or in addition, the extrinsic rewards 108 may be calculated by the reinforcement learning neural network system 100 based on the observations 106 using an extrinsic reward function.

In general the reinforcement learning neural network system 100 controls the agent by, at each of multiple action selection time steps, processing the observation to select an action 112 to be performed by the agent. At each time step, the state of the environment at the time step depends on the state of the environment at the previous time step and the action performed by the agent at the previous time step. Performance of the selected actions 112 by the agent 102 generally causes the environment 104 to transition into new states. By repeatedly causing the agent 102 to act in the environment 104, the system 100 can control the agent 102 to complete a specified task.

In more detail, the reinforcement learning neural network system 100 includes a set of policy neural networks 110, memory storing policy parameters 140, an intrinsic reward engine 120 and a training engine 130.

Each of the policy neural networks 110 is configured to process an input that includes a current observation 106 characterizing the current state of the environment 104, in accordance with the policy parameters 140, to generate a neural network output for selecting the action 112.

In implementations the one or more policy neural networks 110 comprise a value function neural network configured to process the observation 106 for the current time step, in accordance with current values of value function neural network parameters, to generate a current value estimate relating to the current state of the environment. The value function neural network may be a state or state-action value function neural network. That is, the current value estimate may be a state value estimate, i.e. an estimate of a value of the current state of the environment, or a state-action value estimate, i.e. an estimate of a value of each of a set of possible actions at the current time step.

The current value estimate may be generated deterministically, e.g. by an output of the value function neural network, or stochastically e.g. where the output of the value function neural network parameterizes a distribution from which the current value estimate is sampled. In some implementations the action 112 is selected using the current value estimate.

The reinforcement learning neural network system 100 is configured to learn to control the agent to perform a task using the observations 106. For each action, an extrinsic reward 108 is provided from the environment. Furthermore, for each action, an intrinsic reward 122 is determined by the intrinsic reward engine 120. The intrinsic reward engine 120 is configured to generate the intrinsic reward 122 based on the diversity of the policy being trained relative to the other policies in the set of policies. The training engine 130 updates the policy parameters of the policy being trained based on both the extrinsic reward 108 and the intrinsic reward 122. When updating the parameters for a policy neural network, information from at least one other policy may be utilized in order to ensure that diversity is maximized, subject to one or more performance constraints.

The intrinsic reward engine 120 may be configured to generate intrinsic rewards 122 based on state distributions (or state visitation distributions) determined from the policy being trained and one or more other policies. This allows the reward engine 120 to determine the diversity of the policy being trained relative to the one or more other policies. These state distributions may be successor features 140 (described in more detail below). That is, the reinforcement learning neural network system 100 (e.g. the training engine 130 and/or the intrinsic reward engine 120) may determine successor features for each policy. The successor features 140 for each policy may be stored for use in determining the intrinsic reward 122.

Once trained, the set of policies may be implemented by the system 100. This may include implementing the policy set based on a probability distribution over the policy set, wherein the reinforcement learning neural network system 100 is configured to select a policy from the policy set according to the probability distribution and implement the selected policy.

For instance, the probability distribution over the policy set π̅(π) may be a mixed policy. A policy may be randomly selected based on the probability distribution over the policy set. This may occur at time zero (e.g. t=0, s=s₀), after which the selected policy may be followed. Using this method, the system may implement the set of policies for solving a task, allowing the diversity of the policies to be leveraged for improved robustness.

The details of the successor features, intrinsic reward and the method training shall be discussed in more detail below.

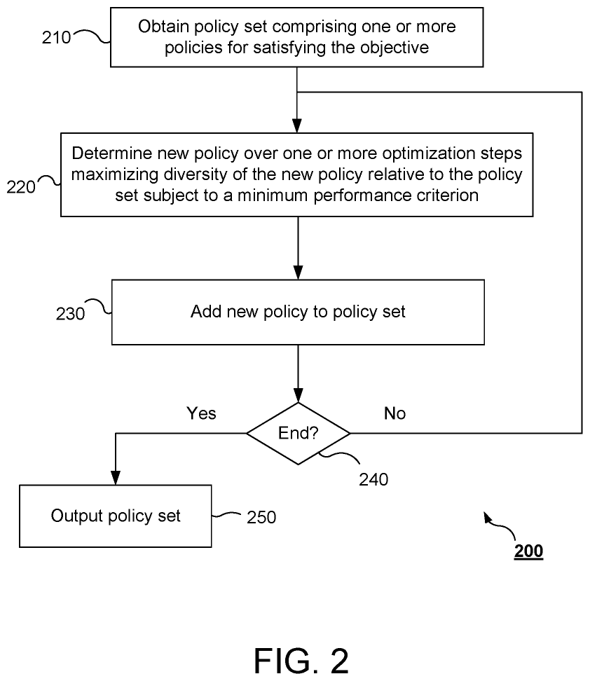

FIG. 2 is a flow diagram of an example process 200 for training a reinforcement learning system. The process 200 trains a set of diverse policies for satisfying a given objective subject to a minimum performance criterion. The objective may also be considered a “task”. It should be noted that the objective in this context is different to the objective function(s) that used in training the reinforcement learning system.

The method begins by obtaining a policy set comprising one or more policies for satisfying the objective 210. The policy set may be obtained from storage (i.e. may be previously calculated) or may be obtained through training (e.g. by applying the agent to one or more states and updating parameters of the policies). Each policy may define a probability distribution over actions given a particular observation of a state of the environment. As shown in FIG. 2, the policy set can be built up by adding each new policy to the policy set after it has been determined (optimized).

Obtaining the policy set 210 may include training one or more policies without using any intrinsic rewards. For instance, this may include training a first policy (e.g. an “optimal” policy) based only on extrinsic rewards. The first policy may be obtained through training that attempts to maximize the extrinsic return without any reference to diversity. After this first policy is determined, subsequent policies may be determined and added to the policy set based on the diversity training methods described herein. The first policy may be used as the basis for a minimum performance criterion applied to subsequent policies. In addition to this first policy, the policy set may include additional policies that may be obtained through other means (e.g. through diversity training).

A new policy is then determined 220. The new policy is determined over one or more optimization steps that maximize the diversity of the new policy relative to the policy set subject to a minimum performance criterion. These optimization steps will be described in more detail below.

According to one implementation, determining the new policy comprises defining a diversity reward function that provides a diversity reward for a given state. The diversity reward may provide a measure of the diversity of the new policy relative to the policy set. The one or more optimization steps may then aim to maximize an expected diversity return based on the diversity reward function under the condition that the new policy satisfies the minimum performance criterion.

In general, the expected return from any reward function rₜ(s) conditioned on an observation of a given state sₜ can also be considered the value V^{π}(sₜ) of the state under a certain policy π. This can be determined as a cumulative future discounted reward:

V^{π}(sₜ)= [symbol] (Rₜ|sₜ)

where Rₜ can be defined as the sum of discounted rewards after time t:

$${R}_{t} = {\sum }_{k = 0}^{∞} {γ}^{k} {r}_{t + k + 1}$$

where γ is a discount factor. Alternatively, the value may be based on the average (undiscounted) reward from following the policy.

Once a new policy is determined, it is added to the policy set 230. The method then determines if an end criterion is reached 240. The end criterion may be a maximum number of iterations, a maximum number of policies added to the set of policies, or any other form of end criterion.

If the end has not been reached, then another policy is determined through steps 220 and 230. If the end is reached, then the policy set is output 250. This output may include local storage for local implementation (e.g. local inference or further local training) or through communication to an external device or network.

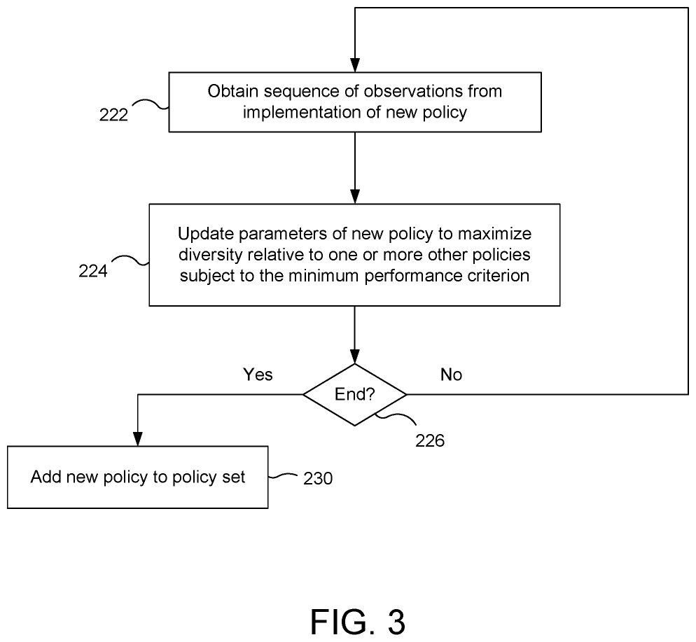

FIG. 3 is a flow diagram of an example process for iteratively updating parameters of a new policy. This generally equates to steps 220 and 230 of FIG. 2.

Firstly, a sequence of observations is obtained from the implementation of the new policy 222. If this is the first iteration, then the policy parameters may be initialized (e.g. at random). The new policy is then implemented over a number of time steps in which an action is selected and applied to the environment in order to obtain an updated observation of the state of the environment. The sequence of observations may be collected over a number of time steps equal to or greater than the mixing time of the new policy.

Following this, the new policy parameters are updated based on an optimization step that aims to maximize the diversity of the new policy relative to one or more other policies (e.g. the policies in the policy set) subject to the minimum performance criterion 224. The update (optimization) step 224 may aim to minimize a correlation between successor features of the new policy and successor features of the policy set under the condition that the new policy satisfies the minimum performance criterion. The details of this update step will be described later.

Following the update, it is determined if the end of the iterative updating steps has been reached 226. For instance, it may be determined if a maximum number of updates has been implemented, or if some evaluation criteria has been met. If not, then steps 222 and 224 are repeated. If so, then the new policy is added to the policy set 230.

### Training Diversity

The methods described herein train a set of policies that maximize diversity subject to a minimum performance criterion. Diversity may be measured through a number of different approaches. In general, the diversity of a number of policies represents differences in the behavior of the policies. This may be measured through differences in parameters of the policies or differences in the expected distribution of states visited by the policies.

A key aspect of the present method is the measure of diversity. The aim is to focus on diverse policies. Advantageously, the diversity can be measured based on the stationary distribution of the policies after they have mixed.

In specific implementations, the diversity is measured based on successor features (SFs) of the policies. Successor features are a measure of the expected state distribution resulting from a policy π given a starting state ρ.

Successor features are based on the assumption that the reward function for a given policy (e.g. the diversity reward) can be parameterised as follows:

r(s,a)=w·ϕ(s,a)

where w is a vector of weights (a diversity vector) characterizing the specific reward in question (e.g. the diversity reward) and ϕ(s, a) is an observable feature vector representing a given state s and action a (a state-action pair). The feature vector ϕ(s, a) may be considered an encoding of a given state s and action a. The feature vector ϕ(s, a) may be bounded, e.g. between 0 and 1 (ϕ(s, a)∈[0,1]^{d} where d is a dimension of the feature vector ϕ(s, a) and of the weight vector w∈ [symbol] ^{d}. The mapping from states and actions to feature vectors can be implemented through a trained approximator (e.g. a neural network). Whilst the above references an encoding of actions and states, a feature vector may alternatively be an encoding of a given state only ϕ(s).

In light of the above, in certain implementations, the diversity reward function is a linear product between a feature vector ϕ(s) that represents at least an observation of the given state s and a diversity vector w characterising the diversity of the new policy relative to the policy set. As mentioned above, the feature vector ϕ(s) represents at least the given state s, but may also represent the action a that led to the given state s. That is, the feature vector may be ϕ(s, a) (conditioned on both the action a and state s).

Given the above, the successor features ψ^{π}(s, a) of a given state s and action a given a certain policy π is the expected feature vectors (the expectation of the features vectors observed from following the policy):

$${ψ}^{π} = {𝔼}_{π} [ {\sum }_{t = 0}^{∞} {γ}^{t - 1} {ϕ}_{i + 1} \vert {s}_{t} = s , {a}_{t} = a ]$$

In practice, the successor features may be calculated by implementing the policy, collecting a trajectory (a series of observed states and actions), and determining a corresponding series of feature vectors. This may be determined over a number of time steps equal to or greater than the mixing time of the policy. The mixing time may be considered the number of steps required for the policy to produce a state distribution that is close to (e.g. within a given difference threshold) of its stationary state distribution. Formally, the mixing time (e.g. the ϵ-mixing time) of an ergodic Markov chain with a stationary distribution d_{π} is the smallest time t such that ∀s₀, TV[Prₜ(⋅|s₀), d_{π}]≤ϵ, where Prₜ(⋅|s₀) is the distribution over states s after t steps starting from s₀, and TV[⋅,] is the total variation distance.

Given the above, the successor features under a stationary state distribution d_{π} can be defined as:

ψ^{π}= [symbol] _{s˜d}_{_{π}}ϕ(s,π(s))

The stationary distribution can be defined as d_{π}=lim_{t→∞}Pr(sₜ=s|s₀˜ρ, π). This may be the case for an ergodic Markov chain. The stationary state distribution can be considered a state distribution that remains unchanged when the policy is applied to it (d_{π}^{T}=d_{π}^{T}P^{π} where P^{π} is a transition matrix of the policy π). The stationary distribution may be a discounted weighting to states encountered by applying the policy, starting from s₀:

$${d}_{π} ( s ) = ( 1 - γ ) {\sum }_{t = 0}^{∞} {γ}^{t} P r ( {s}_{t} = s \vert {s}_{0} ∼ ρ , π )$$

Measuring diversity in the space of SFs allows long term behaviour to be modelled as SFs are defined under the policy's stationary distribution. In contrast, other methods of learning diverse skills often measure diversity before the skill policy mixes.

Implementations described herein attempt to the maximize diversity whilst still meeting a minimum performance criterion. This minimum performance criterion may be based on the return that would be obtained by following the new policy. For instance, the expected return (or value) of a policy may be determined and compared to an optimal expected return (or value). This optimal value may be the value of a first policy determined based only on extrinsic rewards.

Given the above, the diversity of a given set of policies Πⁿ (e.g. a set including the policy set and the new policy) may be maximized based on the successor features ψ^{π} of the policies, subject to a minimum performance criteria (e.g. a certain extrinsic value vₑ^{π} being achieved by the new policy relative to an optimal extrinsic value vₑ*). The objective for training the new policy may therefore be:

$${max}_{{\prod }^{n}} D ( {Ψ}^{n} ) s . t . {v}_{e}^{π} \geq α {v}_{e}^{*} ∀ π ∈ {Π}^{n}$$

where D(ψⁿ) is the diversity of the set of successor features Ψⁿ for all the set of policies Πⁿ and α is a scaling factor for defining the minimum performance criterion. Note that can a control the range of policies that are searched over. In general, the smaller the α parameter the larger the set of α-optimal policies and thus the greater the diversity of the policies found in Πⁿ. In one example, α=0.9, although other values of a may be utilized. Setting α=0 can reduce the setup to the no-reward setting where the goal is to maximize diversity irrespective of extrinsic rewards.

Where diversity is measured based on a diversity reward and where the extrinsic value is measured via an extrinsic reward, each the one or more optimization steps may aim to solve the following objective:

$${π}^{i} = {arg max}_{π} {d}_{π} \cdot {r}_{d}$$

$$s . t . {d}_{π} \cdot {r}_{e} \geq α {v}_{e}^{*}$$

where d_{π} is a state distribution for the policy π (such as the stationary distribution for the policy), r_{d} is a vector of diversity rewards, rₑ is a vector of extrinsic rewards, α is a scaling factor for defining the minimum performance criterion and vₑ*is the optimal extrinsic value (e.g. determined based on a first policy trained based only on extrinsic rewards).

Given the above, the minimum performance criterion can require the expected return that would be obtained by following the new policy to be greater than or equal to a threshold. The threshold may be defined as a fraction a of an optimal value based on the expected return from a first policy that is determined by maximizing the expected return of the first policy. The optimal value may be based on a value function (e.g. that calculates the expected return). Accordingly, the first policy may be obtained through training that attempts to maximize the extrinsic return without any reference to diversity. After this first policy is determined, subsequent policies may be determined and added to the policy set based on the diversity training methods described herein.

The optimal value may be the largest expected return from any of the first policy and the policy set. Accordingly, each time a new policy is added to the policy set, the optimal value may be checked to ensure that the expected return (the value) from this new policy is not greater than the previously highest value. If the expected return (the value) from this new policy is greater than the previously highest value, then the optimal value is updated to the value (the expected return) from the new policy.

Whilst the term “optimal value” is used, this does not necessarily mean that the value has to be the optimum one, i.e. the largest possible value (global maximum value). Instead, it can refers to the fact that it relates to a highest value that has been obtained so far or based on a value that has been achieved through optimizing based only on the extrinsic rewards.

As discussed above, the intrinsic rewards may be determined through a linear product r_{d}(s, a)=w·ϕ(s, a). In some implementations, the intrinsic rewards may be optionally bound in order to make the reward more sensitive to small variations in the inner product (e.g. when the policies being compared are relatively similar to each other). This can be achieved by applying the following transformation

$${\tilde{r}}_{w} ( s ) = \frac{w \cdot ϕ ( s ) + {‖ w ‖}^{2}}{{‖ w ‖}^{2}}$$

and then applying the following non-linear transformation:

$${r}_{d} ( s ) = \frac{( 1 - exp ( - τ {\tilde{r}}_{w} ( s ) ) )}{1 - exp ( τ )}$$

where τ is a normalization temperature parameter.

As discussed above, the new policy may be updated based on both intrinsic and extrinsic rewards. This update may be implemented by solving a constrained Markov decision process (CMDP). This may be solved through gradient decent via use of a Lagrangian multiplier of the constrained Markov decision process, or any other alternative method for solving a CMDP. In this case, the Lagrangian can be considered to be:

L(π,Δ)=−d_{π}·(r_{d}+λrₑ)−λαvₑ*.

On this basis, the optimization objective can be:

$${min}_{π ∈ Π} {max}_{λ \geq 0} L ( π , λ ) .$$

This can be solved by using a Sigmoid activation function σ(λ) on the Lagrange multiplier λ to form an unconstrained reward as a combination of the diversity reward and the extrinsic reward:

r(s)=σ(λ)rₑ(s)+(1−σ(λ))r_{d}(s).

Entropy regularization on A can be introduced to prevent σ(λ) reaching extreme values (e.g. 0 or 1). The objective for the Lagrange multiplier can then be:

ƒ(λ)=σ(λ)(v̅−αvₑ*)−aₑH(σ(λ))

where H(σ(λ)) is the entropy of the Sigmoid activation function σ(λ), aₑ is the weight of the entropy regularization and v̅ is an estimate (e.g. a Monte Carlo estimate) of the total cumulative extrinsic return that the agent obtained in recent trajectories (recent state-action pairs). The Lagrangian λ may be updated through gradient descent. The Lagrangian λ need not be updated at every optimization step, but may be updated every N_{λ} steps.

The estimated total cumulative extrinsic return v̅ can be estimated from an estimation of the average extrinsic rewards. These can be calculated through Monte Carlo estimates:

$${\overline{v}}_{j} = \frac{1}{T} {Σ}_{t = 1}^{T} {r}_{t} ,$$

i.e. the empirical average reward rₜ obtained by the agent in trajectory j. In one example, T may be 1000. The same estimator may be utilized to estimate the average successor features:

$${\overline{Ψ}}_{j} = \frac{1}{T} {Σ}_{r = 1}^{T} {ϕ}_{t} .$$

The sample size T need not be the same for the estimation of the extrinsic return as for the estimation of the successor features.

Accordingly, the extrinsic return can be estimated as the average reward returned over a certain number of time steps t (e.g. after a certain number of actions). The number of time steps may be greater than or equal to the mixing time.

The estimate v̅ⱼ may be further averaged through use of a running average with a decay factor of a_{d}: v̅ⱼ=a_{d}v̅ⱼ₋₁+(1−a_{d})v̅ⱼ. That is, each time a new extrinsic return is determined (e.g. from a new trajectory), it is used to update a running average of estimated extrinsic returns.

Multiple different forms of intrinsic reward shall be discussed herein. The extrinsic reward rₑ can be received from the environment or calculated based on observations of the environment, and is generally a measure of how well the given policy is performing a specific task. Alternatively, in some implementations, the extrinsic reward rₑ can be another diversity reward. That is, the extrinsic return may be determined based on a further diversity reward (e.g. one of the diversity rewards mentioned herein, provided that it differs from the diversity reward that is being used for maximizing the diversity) or based on extrinsic rewards received from implementing the new policy.

The extrinsic rewards may be received from the environment in response to the implementation of the policy (e.g. in response to actions) or may be calculated based on an explicit reward function based on observations. The return can be calculated based on the expected extrinsic rewards in a similar manner to how the diversity return may be calculated (as discussed above).

Algorithm 1 shows a process for determining a set of diverse policies, given an extrinsic reward function and an intrinsic reward function. The method initializes by determining a first (optimal) policy based on maximizing the expected extrinsic return. The optimal value is then set to the value for this first policy and the first policy is added to the set of policies. Following this, multiple policies (up to T policies) are determined. For each new policy πⁱ, a diversity reward r_{d}ⁱ is set based on diversity of the policy relative to the successor features of the previously determined policies in the policy set. The new policy is then determined through a set of optimization steps that maximize that average intrinsic reward value subject to the constraint that the new policy be near-optimal with respect to its average extrinsic reward value. That is, the optimization maximizes the expected diversity return subject to the expected extrinsic return being greater or equal to αvₑ*. Following this, the successor features ψⁱ for the policy πⁱ are determined. The policy πⁱ is then added to the policy set Πⁱ and the successor features ψⁱ of the policy are added to a set of successor features Ψⁱ.

Algorithm 1 Diverse Successive Policies

| | |
|---|---|
| 1: | Input: mechanism to compute rewards rₑ and r_{d}. |
| 2: | Initialize: π⁰ ← arg max_{π∈Π} rₑ · d_{π}, |
| 3: | υₑ* = υ^{π}^{⁰}, Π⁰ = {π⁰} |
| 4: | for i = 1, . . . , T do |
| 5: | Compute diversity reward r_{d}ⁱ = D(Ψⁱ⁻¹) |
| 6: | πⁱ = arg max_{π} d_{π} · r_{d}ⁱ s.t. d_{π} · rₑ ≥ αυₑ* |
| 7: | Estimate the SFs ψⁱ of the policy πⁱ |
| 8: | Πⁱ = Πⁱ⁻¹ ∪ {πⁱ}, Ψⁱ = Ψⁱ⁻¹ ∪ {ψⁱ} |
| 9: | end for |
| 10: | return Π^{T} |

The above approach aims to maximize skill diversity subject to a minimum performance criterion. Skill diversity can be measured using a variety of methods. One approach is to measure skill discrimination in terms of trajectory-specific quantities such as terminal states, a mixture of the initial and terminal states, or trajectories. An alternative approach that implicitly induces diversity is to learn policies that maximize the robustness of the set Πⁿ to the worst-possible reward.

### Diversity via Discrimination

In order to encourage diversity between policies (otherwise known as “skills”), the policies can be trained to be distinguishable from one another, e.g. based on the states that they visit. In this case, learning diverse skills is then a matter of learning skills that can be easily discriminated. This can be through maximizing the mutual information between skills.

To determine diverse policies, an intrinsic reward rᵢ may be defined that rewards a policy that visits states that that differentiate it from other policies. It can be shown that, when attempting to maximize the mutual information, this reward function can take the form of r (s|z)=log p(z|s) p(z) where z is a latent variable representing a policy (or skill). A skill policy π(a|s, z) can control the first component of this reward, p(z|s), which measures the probability of identifying the policy (or skill) given a visited state s. Hence, the policy is rewarded for visiting states that differentiate it from other skills, thereby encouraging diversity.

The exact form of p(z|s) depends on how skills are encoded. One method is to encode z as a one-hot d-dimensional variable. Similarly, z can be represented as z∈{1, . . . , n} to index n separate policies π^{z}.

p(z|s) is typically intractable to compute due to the large state space and can instead be approximated via a learned discriminator q_{ϕ}(z|s). In the present case, p(z|s) is measured under the stationary distribution of the policy; that is, p(z|s)=d_{π}_{^{z}}(s). Based on the above, the objective for maximizing diversity can be written as:

$${𝔼}_{z ∼ p ( z ) , s ∼ d ( {π}^{z} )} [ log p ( z \vert s ) ] = {\sum }_{z} p ( z ) {\sum }_{s} {d}_{{π}^{z}} ( s ) log ( \frac{{d}_{{π}^{z}} ( s ) p ( z )}{{\sum }_{k} {d}_{{π}^{k}} ( s ) p ( k )} )$$

Finding a policy with a maximal value for this reward can be seen as solving an optimization program in d_{π}_{^{z}} (s) under the constraint that the solution is a valid stationary state distribution. The term Σₛ p(s|z) log p(s|z) corresponds to the negative entropy of d_{π}_{^{z}} (s). Accordingly, the optimization may include a term that attempts to minimize the entropy of the state distribution produced by the policy (e.g. the stationary state distribution).

Making use of successor features, the discrimination reward function can be written as:

$${r}_{d} ( s ) = log ( \frac{exp ( ϕ ( s ) \cdot {ψ}^{n} )}{{Σ}_{i = j}^{n} exp ( ϕ ( s ) \cdot {ψ}^{j} )} )$$

where ψⁿ is a running average estimator of the successor features of the current policy.

### Diversity via Robustness

An alternative approach to the above is to seek robustness among the set of policies by maximizing the performance of the policies with rest to the worst case reward. For fixed n, the goal is:

$${max}_{{\prod }^{n} ⊆ \prod } {min}_{w ∈ {B}_{2}} {max}_{{π}^{i} ∈ {\prod }^{n}} {ψ}^{i} \cdot w$$

where B₂ is the [symbol] ₂ unit ball, Π is the set of all possible policies, and Πⁿ={π¹, . . . , πⁿ} is the set of n policies being optimized.

The inner product ψⁱ·w yields the expected value under the steady-state distribution (see Section 2) of the policy. The inner min-max is a two-player zero-sum game, where the minimizing player is finding the worst-case reward function (since weights and reward functions are in a one-to-one correspondence) that minimizes the expected value, and the maximizing player is finding the best policy from the set Πⁿ (since policies and SFs are in a one-to-one correspondence) to maximize the value. The outer maximization is to find the best set of n policies that the maximizing player can use.

Intuitively speaking, the solution Πⁿ to this problem is a diverse set of policies since a non-diverse set is likely to yield a low value of the game, that is, it would easily be exploited by the minimizing player. In this way diversity and robustness are dual to each other, in the same way as a diverse financial portfolio is more robust to risk than a heavily concentrated one. By forcing the policy set to be robust to an adversarially chosen reward it will be diverse.

Notably, the worst-case reward objective can be implemented via an iterative method that is equivalent to a fully corrective Floyd-Warshall (FW) algorithm to minimize the function ƒ=∥ψ^{π}∥₂. As a consequence, to achieve an ϵ-optimal solution, the process requires at most O(log(1/ϵ)) iterations. It is therefore guaranteed to converge on an optimal solution at a linear rate.

The reward for the above can be written as follows:

$${r}_{d} ( s ) = {w}^{′} \cdot ϕ ( s )$$

$$where$$

$${w}^{′} = {min}_{w ∈ {B}_{2}} {max}_{{π}^{i} ∈ {\prod }^{n}} {ψ}^{i} \cdot w$$

that is, w′ is the internal minimization in the above objective.

### Explicit Diversity

The diversity mechanisms discussed above so far were designed to maximize robustness or discrimination. Each one has its own merits in terms of diversity, but since they do not explicitly maximize a diversity measure they cannot guarantee that the resulting set of policies will be diverse.

The following section defines two reward signals designed to induce a diverse set of policies. This is achieved by leveraging the information about the policies' long-term behavior available in their SFs. Both rewards are based on the intuition that the correlation between SFs should be minimized

To motivate this approach, it is noted that SFs can be seen as a compact representation of a policy's stationary distribution. This becomes clear when considering the case of a finite MDP |S|-dimensional “one-hot” feature vectors ϕ whose elements encode the states ϕᵢ(s)= [symbol] {s=i}, where ∥{⋅} is the indicator function. In this special case the SFs of a policy π coincide with its stationary distribution, that is, ψ^{π}=d_{π}. Under this interpretation, minimizing the correlation between SFs intuitively corresponds to encouraging the associated policies to visit different regions of the state space—which in turn leads to diverse behavior. As long as the tasks of interest are linear combinations of the features ϕ∈ [symbol] ^{d}, similar reasoning applies when d<|S|.

This can be solved by attempting to minimize the linear product between successor features. Considering the extreme scenario of a single policy π^{k} in the set Π, the objective would be

$${max}_{{ψ}^{z}} {ψ}^{z} \cdot w$$

where w=−ψ^{k}. Solving this problem is a reinforcement learning problem whose reward is linear in the features weighted by w. Of course, where the set includes multiple policies, then w needs to be defined appropriately.

Two implementations are proposed for w.

Firstly, the diversity vector w may be calculated based on an average of the successor features of the policy set. For instance, the diversity vector w may be the negative of the average of the successor features of the policy set,

$${w}_{average} = - \frac{1}{k} \sum {ψ}^{k} .$$

In this case, the diversity reward for a given state can be considered the negative of the linear product of the average successor features «^{j} of the policy set and the feature vector ϕ(s) for the given state:

$${r}_{d} = - \frac{1}{k} {\sum }_{j = 1}^{k} {ψ}^{j} \cdot ϕ ( s )$$

where k is the number of policies in the policy set. This formulation is useful as it measures the sum of negative correlations within the set. However, when two policies in the set happen to have the same SFs with opposite signs, they cancel each other, and do not impact the diversity measure.

Alternatively, the diversity vector w may be calculated based on the successor features for a closest policy of the policy set, the closest policy having successor features that are closest to the feature vector ϕ(s) for the given state. In this case, the diversity vector w may be determined by determining from the successor features of the policy set the successor features that provide the minimum linear product with the feature vector ϕ(s) for the given state. The diversity vector w may be equal to the negative of these determined closest successor features. The diversity reward for a given state can therefore be considered

r_{d}(s)=minₖ{−ψ^{k}·ϕ(s)}

This objective can encourage the policy to have the largest “margin” from the policy set as it maximizes the negative correlation from the element that is “closest” to it.

### Implementations

The methods described herein provide determine diverse sets of policies that are optimized for performing particular tasks. This provides an improvement over methods that determine policies based on diversity only, or methods that determine a single optimum policy for a certain task. By providing a diverse set of near-optimal policies, this set of policies may be used to provide improved robustness against changes to the environment (equivalent to providing different methods of solving a particular problem).

Furthermore, providing multiple policies can allow a particular user to select a given policy for a certain task. Often times, a user may not know a prior which reward for training will result in a desired result. Thus engineers often train a policy to maximize an initial reward, adjust the reward, and iterate until they reach the desired behavior. Using the present approach, the engineer would have multiple policies to choose from in each attempt, which are also interpretable (linear in the weights). This therefore provides a more efficient means of reinforcement learning, by avoiding the need for additional iterations of training based on adjusted rewards.

Certain implementations train the policies through use of a constrained Markov decision process (CMDP). Whilst it is possible to implement this through a multi-objective Markov decision process, the use of a CMDP provides a number of advantages. First, the CMDP formulation guarantees that the policies that are found are near optimal (i.e. satisfy the performance constraint). Secondly, the weighting coefficient in multi-objective MDPs has to be tuned, while in the present implementations it is being adapted over time. This is particularly important in the context of maximizing diversity while satisficing reward. In many cases, the diversity reward might have no other option other than being the negative of the extrinsic reward. In these cases the present methods will return good policies that are not diverse, while a solution to multi-objective MDP might fluctuate between the two objectives and not be useful at all.

It should be noted that the implementations discuss methods of “optimizing” that can include “maximizing” or “minimizing”. Any reference to “optimizing” relates to a set of one or more processing steps that aim to improve a result of a certain objective, but does not necessarily mean that an “optimum” (e.g. global maximum or minimum) value is obtained. Instead, it refers to the process of attempting to improve a result (e.g. via maximization or minimization). Similarly, “maximization” or “minimization” does not necessarily mean that a global (or even local) maximum or minimum is found, but means that an iterative process is performed to update a function to move the result towards a (local or global) maximum or minimum.

It should also be noted that whilst the term “reward” is discussed herein, these rewards may be negative. In the case of negative rewards, these may equally be considered costs. In this case, the overall objective of a reinforcement learning task would be to minimize the expected cost (instead of maximizing the expected reward or return).

In order for the agent to interact with the environment, the system receives data characterizing the current state of the environment and selects an action to be performed by the agent in response to the received data. Data characterizing a state of the environment will be referred to in this specification as an observation.

In some applications the environment is a real-world environment and the agent is a mechanical agent interacting with the real-world environment. For example, the agent may be a robot interacting with the environment to accomplish a specific task. As another example, the agent may be an autonomous or semi-autonomous land or air or water vehicle navigating through the environment. In these implementations, the actions may be control inputs to control a physical behavior of the robot or vehicle.

In general the observations may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example in the case of a robot the observations may include data characterizing the current state of the robot, e.g., one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these applications the actions may be control inputs to control the robot, e.g., torques for the joints of the robot or higher-level control commands; or to control the autonomous or semi-autonomous land or air or sea vehicle, e.g., torques to the control surface or other control elements of the vehicle or higher-level control commands; or e.g. motor control data. In other words, the actions can include for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g. braking and/or acceleration of the vehicle.

In some cases the system may be partly trained using a simulation of a mechanical agent in a simulation of a real-world environment, and afterwards deployed to control the mechanical agent in the real-world environment that was the subject of the simulation. In such cases the observations of the simulated environment relate to the real-world environment, and the selected actions in the simulated environment relate to actions to be performed by the mechanical agent in the real-world environment

Whilst this application discusses diversity rewards based on the diversity of policies, extrinsic rewards may also be obtained based on an overall objective to be achieved. In these applications the extrinsic rewards/costs may include, or be defined based upon the following:
i. One or more rewards for approaching or achieving one or more target locations, one or more target poses, or one or more other target configurations. One or more rewards dependent upon any of the previously mentioned observations e.g. robot or vehicle positions or poses. For example in the case of a robot a reward may depend on a joint orientation (angle) or velocity, an end-effector position, a center-of-mass position, or the positions and/or orientations of groups of body parts.
ii. One or more costs e.g. negative rewards, may be similarly defined. A negative reward or cost may also or instead be associated with force applied by an actuator or end-effector, e.g. dependent upon a threshold or maximum applied force when interacting with an object. A negative reward may also be dependent upon energy or power usage, excessive motion speed, one or more positions of one or more robot body parts e.g. for constraining movement.

Objectives based on these extrinsic rewards may be associated with different preferences e.g. a high preference for safety-related objectives such as a work envelope or the force applied to an object.

A robot may be or be part of an autonomous or semi-autonomous moving vehicle. Similar objectives may then apply. Also or instead such a vehicle may have one or more objectives relating to physical movement of the vehicle such as objectives (extrinsic rewards) dependent upon: energy/power use whilst moving e.g. maximum or average energy use; speed of movement; a route taken when moving e.g. to penalize a longer route over a shorter route between two points, as measured by distance or time. Such a vehicle or robot may be used to perform a task such as warehouse, logistics, or factory automation, e.g. collecting, placing, or moving stored goods or goods or parts of goods during their manufacture; or the task performed may comprise a package delivery control task. Thus one or more of the objectives may relate to such tasks, the actions may include actions relating to steering or other direction control actions, and the observations may include observations of the positions or motions of other vehicles or robots.

In some other applications the same observations, actions, and objectives may be applied to a simulation of a physical system/environment as described above. For example a robot or vehicle may be trained in simulation before being used in a real-world environment.

In some applications the agent may be a static or mobile software agent i.e. a computer programs configured to operate autonomously and/or with other software agents or people to perform a task. For example the environment may be an integrated circuit routing environment and the agent may be configured to perform a routing task for routing interconnection lines of an integrated circuit such as an ASIC. The objectives (extrinsic rewards/costs) may then be dependent on one or more routing metrics such as an interconnect resistance, capacitance, impedance, loss, speed or propagation delay, physical line parameters such as width, thickness or geometry, and design rules. The objectives may include one or more objectives relating to a global property of the routed circuitry e.g. component density, operating speed, power consumption, material usage, or a cooling requirement. The observations may be observations of component positions and interconnections; the actions may comprise component placing actions e.g. to define a component position or orientation and/or interconnect routing actions e.g. interconnect selection and/or placement actions.

In some applications the agent may be an electronic agent and the observations may include data from one or more sensors monitoring part of a plant or service facility such as current, voltage, power, temperature and other sensors and/or electronic signals representing the functioning of electronic and/or mechanical items of equipment. The agent may control actions in a real-world environment including items of equipment, for example in a facility such as: a data center, server farm, or grid mains power or water distribution system, or in a manufacturing plant or service facility. The observations may then relate to operation of the plant or facility, e.g. they may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility. The objectives (defining the extrinsic rewards/costs) may include one or more of: a measure of efficiency, e.g. resource usage; a measure of the environmental impact of operations in the environment, e.g. waste output; electrical or other power consumption; heating/cooling requirements; resource use in the facility e.g. water use; a temperature of the facility; a count of characteristics of items within the facility.

In some applications the environment may be a data packet communications network environment, and the agent may comprise a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The objectives may provide extrinsic rewards/costs for maximizing or minimizing one or more of the routing metrics.

In some other applications the agent is a software agent which manages distribution of tasks across computing resources e.g. on a mobile device and/or in a data center. In these implementations, the observations may include observations of computing resources such as compute and/or memory capacity, or Internet-accessible resources; and the actions may include assigning tasks to particular computing resources. The objectives may include extrinsic rewards dependent upon (e.g. to maximize or minimize) one or more of: utilization of computing resources, electrical power, bandwidth, and computation speed.

In some other applications the environment is an Internet or mobile communications environment and the agent is a software agent which manages a personalized recommendation for a user. The observations may comprise (features characterizing) previous actions taken by the user; the actions may include actions recommending items such as content items to a user. The extrinsic rewards may relate to objectives to maximize or minimize one or more of: an estimated likelihood that the user will respond favorably to being recommended the (content) item, a constraint on the suitability of one or more recommended items, a cost of the recommended item(s), and a number of recommendations received by the user (optionally within a time span.

Corresponding features to those previously described may also be employed in the context of the above system and computer storage media.

The methods described herein can be implemented on a system of one or more computers. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a PyTorch framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method for training a neural network system by reinforcement learning, the neural network system being configured to receive an input observation characterizing a state of an environment interacted with by an agent and to select and output an action in accordance with a policy aiming to satisfy an objective, the method comprising:
obtaining a policy set comprising one or more policies for satisfying the objective;
determining a new policy based on the one or more policies, wherein the determining includes one or more optimization steps that aim to maximize a diversity of the new policy relative to the policy set under the condition that the new policy satisfies a minimum performance criterion based on an expected return that would be obtained by following the new policy.

2. The method of claim 1 wherein the diversity is measured based on an expected state distribution for each of the new policy and the one or more policies in the policy set.

3. The method of claim 1, wherein:
determining the new policy comprises defining a diversity reward function that provides a diversity reward for a given state, the diversity reward providing a measure of the diversity of the new policy relative to the policy set;
the one or more optimization steps aim to maximize an expected diversity return based on the diversity reward function under the condition that the new policy satisfies the minimum performance criterion.

4. The method of claim 3 wherein the one or more optimization steps aim to minimize a correlation between successor features of the new policy and successor features of the policy set under the condition that the new policy satisfies the minimum performance criterion.

5. The method of claim 3, wherein:
the diversity reward function is a linear product between a feature vector ϕ(s) that represents an observation of the given state 3 and a diversity vector w characterising the diversity of the new policy relative to the policy set.

6. The method of claim 5 wherein the diversity vector w is calculated based on:
an average of the successor features of the policy set; or
the successor features for a closest policy of the policy set, the closest policy having successor features that are closest to the feature vector ϕ(s) for the given state.

7. The method of claim 5 wherein the diversity vector w is calculated based on the successor features for a closest policy of the policy set, the closest policy being having successor features that are closest to the feature vector ϕ(s) for the given state, wherein the diversity vector w is determined by determining from the successor features of the policy set, the successor features that provide the minimum linear product with the feature vector ϕ(s) for the given state.

8. The method of claim 3, wherein each of the one or more optimization steps comprises:
obtaining a sequence of observations of states from the implementation of the new policy; and
updating parameters of the new policy to maximize a linear product between the sequence of observations and the diversity reward under the condition that the minimum performance criterion is satisfied.

9. The method of claim 1, wherein the one or more optimization steps aim to determine a new policy that maximizes a measure of mutual information between policies and states based on the new policy and the policy set under the condition that the new policy satisfies the minimum performance criterion.

10. The method of claim 1, wherein the one or more optimization steps include:
determining a worst case reward function based on the policy set;
determining a new policy that maximizes an expected worst case return calculated based on the worst case reward function under the condition that the new policy satisfies the minimum performance criterion.

11. The method of claim 1, wherein the expected return that would be obtained by following the new policy is determined based on extrinsic rewards received from implementing the new policy.

12. The method of claim 1, wherein the minimum performance criterion requires the expected return that would be obtained by following the new policy to be greater than or equal to a threshold.

13. The method of claim 12 wherein the threshold is defined as a fraction of an optimal value based on the expected return from a first policy that is determined by maximizing the expected return of the first policy.

14. The method of claim 1, wherein obtaining a policy set comprises obtaining a first policy through one or more update steps that update the first policy in order to maximize the expected return of the first policy.

15. The method of claim 1, further comprising:
adding the determined new policy to the policy set; and
determining a further new policy based on the policy set, wherein the determining includes one or more optimization steps that aim to maximize a diversity of the further new policy relative to the policy set under the condition that the further new policy satisfies a minimum performance criterion based on an expected return that would be obtained by following the further new policy

16. The method of claim 1, further comprising:
implementing the policy set based on a probability distribution over the policy set, wherein the neural network system is configured to select a policy from the policy set according to the probability distribution and implement the selected policy.

17. The method of claim 1, wherein the new policy is determined by solving a constrained Markov decision process.

18. The method of claim 1, wherein the agent is a mechanical agent, the environment is a real-world environment, and the actions are actions taken by the mechanical agent in the real-world environment to satisfy the objective.

19. A system comprising one or more computers and one or more storage devices storing instructions that when executed by the one or more computers cause the one or more computers to perform operations for training a neural network system by reinforcement learning, the neural network system being configured to receive an input observation characterizing a state of an environment interacted with by an agent and to select and output an action in accordance with a policy aiming to satisfy an objective, the operations comprising:
obtaining a policy set comprising one or more policies for satisfying the objective; determining a new policy based on the one or more policies, wherein the determining includes one or more optimization steps that aim to maximize a diversity of the new policy relative to the policy set under the condition that the new policy satisfies a minimum performance criterion based on an expected return that would be obtained by following the new policy.

20. One or more computer storage media storing instructions that when executed by one or more computers cause the one or more computers to perform operations for training a neural network system by reinforcement learning, the neural network system being configured to receive an input observation characterizing a state of an environment interacted with by an agent and to select and output an action in accordance with a policy aiming to satisfy an objective, the operations comprising:
obtaining a policy set comprising one or more policies for satisfying the objective; determining a new policy based on the one or more policies, wherein the determining includes one or more optimization steps that aim to maximize a diversity of the new policy relative to the policy set under the condition that the new policy satisfies a minimum performance criterion based on an expected return that would be obtained by following the new policy.
